(19) United States
(12) Patent Application Publication
(10) Pub. No.: US 2010/0082293 A1
(43) Pub. Date: Apr. 1, 2010

(54) COMPRESSED AIR SYSTEM MONITORING AND ANALYSIS

(75) Inventors: Edward P. Mitchell, Bedford, NH (US); Joseph Fouad, Dix Hills, NY (US); Jeffrey Wright, Thornton, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Compressor Energy Solutions, Inc., Manchester, NH (US)

(21) Appl. No.: 12/567,465

(22) Filed: Sep. 25, 2009

Related U.S. Application Data
(60) Provisional application No. 61/100,533, filed on Sep. 26, 2008.
(60) Provisional application No. 61/101,204, filed on Sep. 30, 2008.

(51) Int. Cl. G06F 15/00; G06F 17/40; G08B 21/00

(52) U.S. Cl. 702/182; 702/187; 340/540; 702/188

(57) ABSTRACT

Techniques are disclosed for providing robust, comprehensive measurement and analysis for optimizing efficiency of compressed air systems. The techniques provided can be implemented, for example, in a network appliance local to the target compressed air system, and/or in a server configured to remotely monitor and evaluate the target system. On-site data logging as well as on-site or remote data analysis can be enabled, along with onboard data consolidation. Meters (e.g., airflow, air pressure, power, and/or acoustic) are deployed at the target system and provide data upon which the analysis is based.

### RELATED APPLICATIONS

This application claims the benefit of U.S. Application Nos. 61/100,533, filed Sep. 26, 2008, and 61/101,204, filed Sep. 30, 2008. Each of these applications is herein incorporated by reference in its entirety.

### FIELD OF THE INVENTION

The invention relates to compressed air systems, and more particularly, to monitoring and analysis of such systems.

### BACKGROUND OF THE INVENTION

Compressed air can be useful in many applications, including operations where pneumatic tools and/or controlled air-blasts are employed in manufacturing goods or repair shops. A compressed air system generally includes a supply-side having one or more air compressors for generating compressed air and equipment to prepare it for use (such as dryers, separators, and filters), and a demand-side having a compressed air distribution system that includes tools and/or machines that operate on compressed air from the supply-side.

A significant issue associated with compressed air systems is efficiency. Of particular importance is the efficiency related to the energy (electricity) spent on the supply-side to generate the compressed air, relative to the actual consumption on the demand-side. The compressed air delivery system and applications are subject to waste due to leaks, inappropriate uses, and artificial demand. According to the Compressed Air Challenge® (CAC), most compressed air systems use considerably more energy than is needed to support the demand. Compressed air systems usually have a wire-to-work efficiency of around 10%, which is very low. Typically, compressed air efficiency system analysis either focuses on the demand-side or the supply-side.

For instance, most engineering audits look at the demand-side of the system, with a focus on reducing leaks, eliminating inappropriate uses/consumers, and optimizing the delivery system. But, reducing the compressed air consumption does not necessarily translate into proportional electrical savings. For example, if in a given system the consumption of compressed air is reduced by 30%, a modulation-controlled air compressor will still be running at 91% of its horsepower. In reality, the system's energy consumption has been reduced by only 9%.

Another common approach is to focus on the supply-side, looking at the air compressor package, dryers, filters, separators, and pressure/flow control systems. To this end, air compressor suppliers try to provide the best fit given the needs of a particular application. But such an approach does not necessarily provide a comprehensive assessment of real needs for a given system, and air compressor suppliers are particularly focused on selling more air compressors.

What is needed, therefore, are techniques for providing robust, comprehensive monitoring and analysis for the entire compressed air system.

### SUMMARY OF THE INVENTION

One embodiment of the present invention provides a data logging network appliance (DLNA) device. The device includes a data logger for logging parameters associated with a compressed air system deployed at a facility, and a consolidation module for consolidating logged data. In one particular case, the device may include a data analysis module for analyzing the logged data for unexpected data. In one such case, in response to detecting unexpected data, the data analysis module causes an alert to be issued. In another particular case, the device may include a data analysis module for establishing an airflow-to-power consumption profile of the compressed air system, wherein the profile is based on actual power consumed by the system, airflow required by the facility, and air pressure provided to the facility. In another particular case, the device may include a data analysis module for optimizing supply of compressed air to the compressed air system with a refined view of compressed air usage based on reduced demand, by identifying air compressors and/or supply-side equipment that are properly sized for the compressed air system. In another particular case, the data logger is adapted to receive data from one or more airflow meters, and one or more power meters. In one such case, the data logger is further adapted to receive data from at least one of an air pressure meter and an ultrasonic acoustic detector. In another particular case, the device is capable of operatively coupling to a network and communicating with a remote server. In another particular case, the onboard consolidation module is configured to compute a single data value that is representative of all data samples collected during a designated time interval. In one such case, the single data value is an average value of all data samples collected during a designated time interval. In another particular case, the onboard consolidation module is configured to compute at least one of average, median, mode, minimum, and maximum values for a set of data samples collected during a designated time interval.

Another embodiment of the present invention provides a variation on the previously described DLNA device. In this example case, the device includes a data logger for logging parameters associated with a compressed air system deployed at a facility, wherein the data logger is adapted to receive data from one or more airflow meters, one or more air pressure meters, and one or more power meters. The device further includes a consolidation module configured to compute at least one of average, median, mode, minimum, and maximum values for a set of data samples collected during a designated time interval. The device further includes a data analysis module for analyzing the logged data for unexpected data. The device further includes a network interface for operatively coupling to a network and communicating consolidated values computed by the consolidation module to a remote server. In one such configuration, in response to detecting unexpected data, the data analysis module causes an alert to be issued. In another such configuration, the data logger is further adapted to receive data from an ultrasonic acoustic detector. In another such configuration, the data logger is further configured to compute an average value of all data samples collected during the designated time interval, and a plurality of such average values are reported to the remote server. In another such configuration, at least one of the device or the remote server is capable of establishing an airflow-to-power consumption profile of the compressed air system, and for optimizing supply of compressed air to the compressed air system with a refined view of compressed air usage based on reduced demand, by identifying air compressors and/or supply-side equipment that are properly sized for the compressed air system. Here, the airflow-to-power consumption profile can be based on actual power consumed by the system, airflow required by the facility, and air pressure provided to the facility.

Other variations and embodiments will be apparent in light of this disclosure, such as a method for monitoring and analyzing a target compressed air system deployed at a facility.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a compressed air system configured with monitoring and analysis capability, in accordance with an embodiment of the present invention.

FIG. 2 is a data logging network appliance (DLNA) configured in accordance with an embodiment of the present invention.

FIG. 3 is an analysis server configured in accordance with an embodiment of the present invention.

FIG. 4 illustrates a Compressed Air Challenge® (sponsored by the U.S. Dept of Energy) chart illustrating the efficiency of different compressed air controllers, which can be used to estimate savings projections in accordance with an embodiment of the present invention.

FIG. 5 illustrates a method for monitoring and analyzing a target compressed air system deployed at a facility, in accordance with an embodiment of the present invention.

### DETAILED DESCRIPTION OF THE INVENTION

Techniques are disclosed for providing robust, comprehensive monitoring and analysis for compressed air systems. The techniques provided can be implemented, for example, in a network appliance local to the target compressed air system, and/or in a server configured to remotely monitor and evaluate the target system. Meters (e.g., airflow, air pressure, power, and acoustic meters) can be deployed at the target system to provide data upon which the analysis is based.

For instance, the demand-side can be assessed, to quantify leaks, eliminate inappropriate uses, and lower air pressure where appropriate, and to generally determine the actual needs of a target compressed air system. Sensors and/or metering devices deployed at the system can be used to collect power consumption, airflow, and air pressure, as well as other pertinent system parameter data. The collected data can then be provided to hosted software (or other suitable processing module) to perform analysis and reporting on airflow-to-power consumption.

The supply-side can then be assessed. Based on the target system's actual compressed air usage profile, adjusted for planned demand reduction, a projected energy consumption can be computed under different scenarios. This information allows the target system manager to adjust the compressed air production process accordingly (e.g., by selecting and powering an appropriate number of compressors specifically designed to meet the needs for the planned demand, as identified and reported by the techniques provided herein).

A plan can be provided that shows target savings, as well as other efficiency-based features and incentives such as utility rebate forms and a carbon emission reduction report. Additional features to facilitate data harvesting and compressor system analysis can be provided, such as on-line worksheets and tools to calculate savings in electric usage, on-line comparative analysis of different compressors (e.g., based on data sheets publicly available from the Compressed Air and Gas Institute, or CAGI), and heat recovery worksheets.

In one particular embodiment, the techniques described herein are employed in a three step methodology, including: 1) establishing a profile of the target system, including a detailed airflow-to-power consumption profile; 2) reducing demand by identifying and fixing leaks, identifying and eliminating inappropriate uses of compressed air, and reducing overall target system air pressure and shrinking artificial demand; and 3) optimizing supply with a refined view of compressed air usage, by identifying air compressors and/or supply-side equipment that are properly sized for the target system and establishing a comprehensive control strategy to meet the varying demands on the target system. In some such embodiments, this methodology can be carried out on the target system while the system is in full production (e.g., there is no need to suspend or otherwise modify operations to perform the methodology).

Compressed Air System

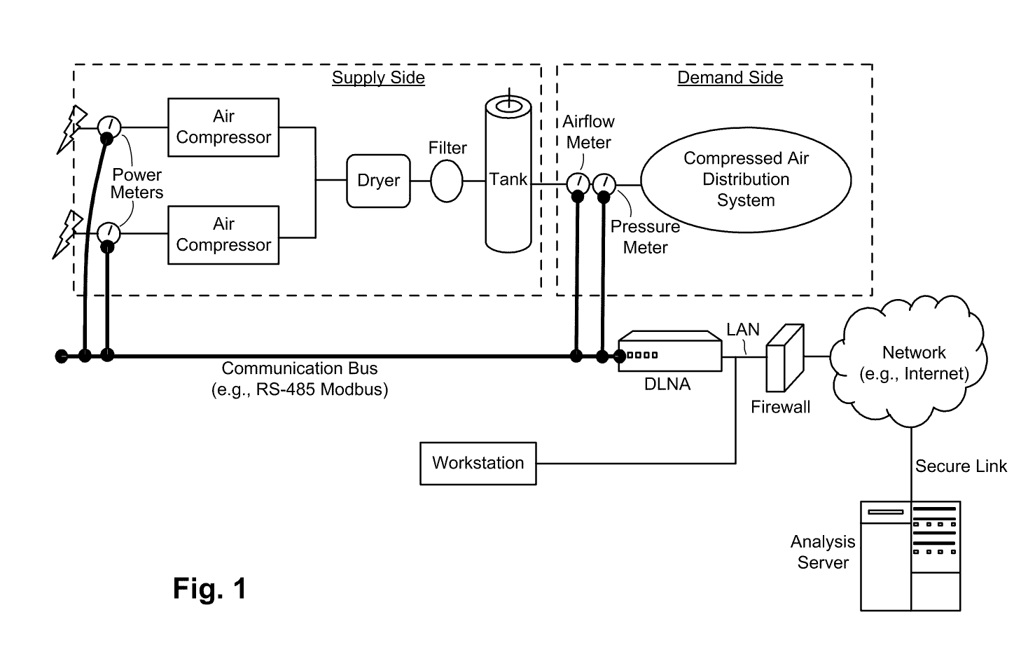

FIG. 1 is an example compressed air system configured with monitoring and analysis capability, in accordance with an embodiment of the present invention. As will be appreciated, embodiments of the present invention can operate independently of the topology of the target compressed air system, and the present invention is not intended to be limited to any particular compressed air system or set of compressed air systems. Rather, the techniques described herein can be employed with any compressed air system where system efficiency is a concern.

As can be seen, the compressed air system of this example embodiment includes a supply-side and a demand-side. The supply-side includes two air compressors operatively coupled to a dryer. The dryer is operatively coupled to a filter, which is operatively coupled to a storage tank. Each of these components and the coupling between them can be implemented, for example, as conventionally done. In addition, there is a power meter operatively coupled to the power input of each compressor, so that the power usage of the individual compressors can be monitored. The demand-side includes a compressed air distribution system, which may include any number of compressed air consumers, such as pneumatic tools and/or other equipment that employs compressed air (e.g., assembly line operations that use a blast of air to clear a surface or to open a bag to be filled). The consumers may be organized, for example, in workstations or clustered groups or in an assembly line fashion (e.g., row-based operations), or they may be deployed in an irregular or ad hoc fashion (e.g., open floor plan with numerous fixtures that allow for plugging into the compressed air system). In any such cases, the various consumers of the distribution system can be coupled to compressed air supply lines as typically done (e.g., using flexible pneumatic hose and/or rigid pneumatic piping operatively coupled to a main supply line). In general, the compressed air distribution system can be implemented with conventional technology, and may have any number of configurations ranging from single room systems to plant-wide systems to multi-building systems. In addition, the compressed air distribution system includes an airflow meter and air pressure meter (transducer), each operatively coupled to the main supply line of the compressed air distribution system, to monitor airflow and air pressure, respectively, into the demand-side. Other components and features not shown on the supply-side and demand-side may be included in other embodiments, and there may be numerous variations in target system topology, as will be appreciated in light of this disclosure.

In this example embodiment, the power meters of the supply-side and the airflow and air pressure meters of the demand-side are operatively coupled to a communication bus, which in this example embodiment is implemented with a RS-485 Modbus (other suitable bus technologies can also be used here, whether serial or parallel in nature). The communication bus is operatively coupled to a data logging network appliance (DLNA) configured to log and report data that characterizes (or can be used to characterize) efficiency and other particulars of the compressed air system. In this particular embodiment, the power meters measure the actual power consumed (e.g., in kWh), and the airflow meter measures the airflow (e.g., in CFM) demand for compressed air from the facility. The pressure meter measures air pressure (e.g., in PSI) to assess the compressors ability to satisfy the airflow demand. Pressure drops below the minimum threshold for plant operation indicate that the supply (e.g., the air compressors, filters, dryers) or the distribution system (e.g., the piping) is not properly sized to meet the needs of the compressed air consumers in the plant. Such measured data is logged by the DLNA, and made available for transmission to the analysis server. As shown, the DLNA can be protected behind a firewall and is communicatively coupled with the analysis server via a secure link (e.g., VPN) over the Internet. Other protected communication link technologies (e.g., SSL) can be employed here as well; alternatively, the link between the DLNA and the server need not be protected, if acceptable to do so. The analysis server is programmed or otherwise configured to receive data logged and reported by the DLNA over a VPN or other protected link, and may perform analysis on that data and compute various recommendations based on that data and analysis. In addition, the analysis server may also be accessed by one or more workstations provided, for example, on a local area network (LAN) behind the firewall at the site of the compressed air system (one such workstation is shown in FIG. 1). The link coupling the workstation to the server can be established using conventional technology (e.g., TCP/IP), and may be secured (e.g., SSL) if so desired.

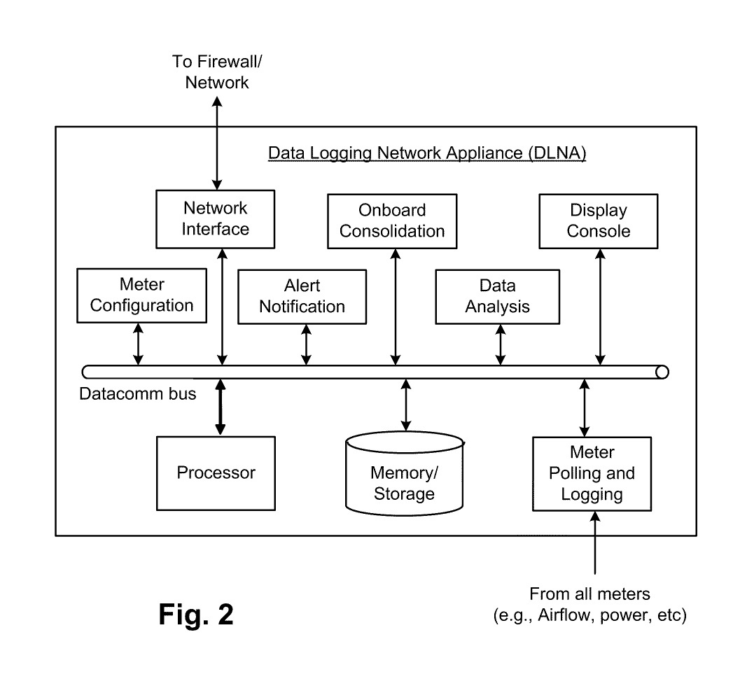

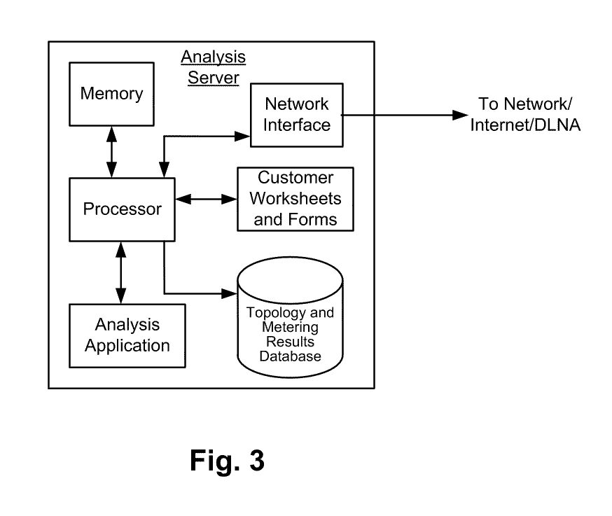

The DLNA can be configured to retrieve meter reading data at regular intervals (e.g., default is every 3 seconds). A user console on the DLNA can be used to display the readings from each meter in histogram form (or other desirable form), providing a consolidated view from all of the meters. In some embodiments, the DLNA can be programmed or otherwise configured with threshold settings and an escalation policy to send alerts when a meter reports an out-of-bounds reading. Since pressure fluctuations in a compressed air system are not uncommon, the DLNA may be further configured to suppress an alert until the threshold crossing has been observed for several consecutive sampling periods. For example, certain equipment in the facility may require a nominal air pressure for proper operation (e.g., 80 PSI). When the DLNA observes the pressure drop close to that pressure (e.g., 85 PSI), and further observes the pressure stay at that level for more than a number sampling periods (e.g., 3 sampling periods, or a total time period of 9 seconds assuming a sampling rate of every 3 seconds), the DLNA can be configured to issue a warning notification to facilities personnel (e.g., directly or via the analysis server). Likewise, when the DLNA observes the pressure drop below the nominal pressure, the DLNA can be configured to send a notification, for instance, to the analysis server and escalating notifications can be issued via SMS and e-mail (or other suitable messaging mechanism) to the appropriate personnel. Escalation policies and contact information can be stored, for example, in the facility profile on the analysis server. Additional details regarding the DLNA and the analysis server are provided with reference to FIGS. 2 and 3, respectively.

Variations on the topology in shown FIG. 1 will be apparent in light of this disclosure. For instance, the optional firewall may be integrated directly into the DLNA, or by-passed. Note, however, that the DLNA can initiate a link to the analysis server, allowing it to pass through any corporate firewalls without reconfiguring the firewall settings Likewise, processing functionality of the DLNA may be pushed to the server, and vice-versa, depending on factors such as network traffic associated with the DLNA. In addition, other embodiments may employ wireless technology (e.g., 802.11 transceivers) or optical fiber to communicatively couple the power, airflow, and/or air pressure meters directly to a port of the DLNA. In short, any communication mediums and protocols (e.g., wired, wireless, fiber, network, direct line or dedicated channel, or other suitable communication medium, and/or encryption, authentication, or other such security measures and protocols) can be used to operatively couple the power and airflow meters, DLNA and analysis server to a target compressed air system to carry out functionality described herein.

Establishing System Profile

The system profile generally identifies all of the consumers of compressed air in the target system, along with the purpose and needs of each consumer. The profile also reflects the compressed air production process (including any air compressors, dryers, filters, separators, pressure/flow controls) and distribution system. In one particular embodiment, on-line worksheets can be provided to the on-site workstation by the analysis server, wherein the worksheets can be used to effectively prompt and step the manager (or other personnel) of the target compressed air system through the process of capturing target compressed air system components and their pertinent characteristics (e.g., manufacturer, maximum PSI, horsepower, etc).

As previously discussed, the example embodiment shown in FIG. 1 logs the actual power consumed, the airflow required by the facility, and air pressure provided to the facility. Thus, the consumption of power and consequent airflow demand for a given period of time (e.g., one week) as measured using meters equipped with data logging can be used to construct a profile of the target system's efficiency (e.g., airflow-to-power consumption profile). This can all be accomplished on the target system while in production, and there is no need to suspend operations to perform any analysis. In addition, the analysis server may include a database of the published CAGI data sheets. As is known, the Compressed Air and Gas Institute (CAGI) has published a standard form for reporting air compressor performance specifications (see http://www.cagi.org/verification/ea_sheets.htm), and most rotary screw compressor manufacturers have published CAGI data sheets for their equipment.

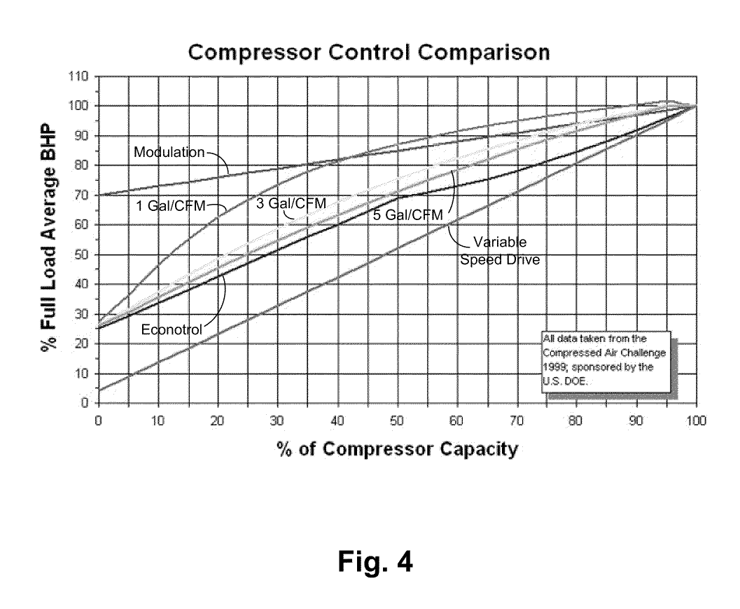

In more detail, the analysis server can be configured with a web interface that allows a user to create a proposed alternate compressor configuration using information from the CAGI datasheets, cross-referenced with the U.S. Dept. of Energy Compressor Control performance profile to project the energy consumption of an air compressor (or multiple compressors controlled by a sequencer) against the measured airflow demand from the facility, as described herein. Using the actual measured airflow demand as a function of air compressor capacity (from published CAGI data) and cross-referencing those measurements with the U.S. Dept. of Energy Compressor Control standard performance curves (such as those shown in FIG. 4) allows the analysis server to provide estimated savings projections that are both accurate and practical. In particular, FIG. 4 illustrates that, based on the compressor control type, an incremental amount of power required to generate an incremental amount of airflow can be disproportionate. For example, an air compressor with Modulation control operating at 65% airflow capacity is consuming 90% of its full load power (kW). Whereas a Variable Speed Drive (VSD) controller is only using 67% of its full load power at 65% airflow capacity. Using the measured airflow adjusted for demand reduction, as a function of the rated airflow capacity of the compressor(s), the percentage of power is derived and multiplied by the full load power consumption (kW) to calculate the projected power consumption.

The energy savings calculation, in accordance with an embodiment of the present invention, is shown here:

ΔkWh=kWhₘ−Σ(CF(PC)×FP×Hrs_{PC})

PC=AC(CFMₘ−DRₚ)

where:
kWhₘ=kilowatt hours, measured;
Σ=Sum of projected power consumption at corresponding airflow duration in 5% increments (0 to 100%);
PC=Percentage of airflow capacity in 5% increments;
CF=Compressor factor, CF is the percentage of power (full loaded rated capacity) that is consumed when producing a percentage of maximum airflow;
Hrs_{PC}=hours of operation at percentage of airflow capacity;
FP=Full load power of air compressor;
AC=Function to calculate percentage of rated Airflow Capacity (rounded to nearest 5%);
CFMₘ=Airflow in cubic feet per minute, measured; and
DRₚ=Demand reduction, projected.
   The daily kWh can be computed as the average power consumption times the number of hours at that operating level. The daily cost can be computed as the daily kWh times the blended cost per kWh. The blended cost per kWh can be configured in the project profile on the analysis server.

Reducing Demand

It is not uncommon for 20-50% of a compressor's output to be lost to waste. Thus, minimizing air leaks is important. Leaks can be detected, for example, with an ultrasonic acoustic detector/meter. Some such detectors are capable of estimating the size of each leak, such as detectors commercially available from UE Systems Inc. In addition, by selectively locating and positioning such leak detectors in specific areas, the detectors can be used to identify the location and size of an air leak (e.g., acoustic detector in zone B is indicating a leak having a size that exceeds acceptable leak threshold). In one embodiment, a leak calculator can be accessed from the analysis server (e.g., via a workstation local to the target compressed air system), so as to allow a user to identify the location of a leak and how much that leak is costing, and an estimate of savings if the leak is eliminated. Other known information related to compressed air system leaks is provided at Appendix A of the previously incorporated U.S. Application No. 61/101,204, which includes material published by Compressed Air Challenge®.

Over time, a compressed air system may grow or change, with more devices being added and/or upgraded, while other equipment is retired. In addition, new leaks may occur, particularly as more users tap into the target system, and the originally deployed piping and air-receivers layout may no longer be efficient. Thus, on-line worksheets accessible via the analysis server can be used to elicit pertinent information, so that such changes can be accommodated in a revised target system profile. For instance, the servable worksheets may be used to identify current compressed air consumers, equipment or processes using the most air, how much air pressure is used by each piece of equipment or process, and the distance between compressed air consumers and the available air compressor(s). In addition, servable worksheets may ask specific questions to elicit specific information about the target system. For example: Is compressed air used for drying or cooling? Once such on-line worksheet questions are answered, inappropriate uses can be eliminated (e.g., applications using compressed air can be switched to less expensive means, or have their use of compressed air modified to a more efficient usage). Other examples of known inappropriate uses of compressed air are provided in Appendix B of the previously incorporated U.S. Application No. 61/101,204, which includes materials published by Compressed Air Challenge® and U.S. Department of Energy. In any such cases, the analysis server can be programmed or otherwise configured to analyze responses provided via the on-line worksheet, and make appropriate recommendations. The recommendations can then be provided (e.g., via an email, text message, or other suitable message) back to the requestor completing the worksheet.

Because of typical inefficiencies associated with a compressed air system, many such systems operate at a higher air pressure than is actually necessary. For example, consider a machine in a plant or deployment site that requires 100 PSI to operate properly, but due to the distance between the machine and the nearest air compressor, the system's air pressure is actually run to 125 PSI so that 100 PSI gets delivered to that machine. To exacerbate this situation, any leaks in the system are amplified by running at a higher air pressure. This is known as artificial demand, because it exaggerates the impact of existing leaks. Reducing air pressure to an appropriate level can help eliminate or reduce this problem.

Optimizing Compressed Air Production

Using the airflow-to-power consumption profile determined during the target system profiling analysis, the maximum target airflow can be adjusted downward to reflect projected demand reduction. Demand reduction can be achieved by leak remediation, eliminating inappropriate uses (e.g., open blows, depreciated or malfunctioning equipment, etc), and reducing air pressure. Thus, a modified demand profile is provided. If there is only one compressor in the target system, then the efficiency of that compressor can be estimated under the newly modified demand profile. That compressor efficiency can then be compared with the efficiency of other comparable or otherwise suitable compressors, for example, using the compressor control type comparison data published by Compressed Air Challenge® (such as that found on-line at http://www.compressedairchallenge.org) and published CAGI data from major air compressor manufacturers. Thus, a suitable but more efficient compressor can be recommended.

In one particular embodiment, the analysis server maintains or otherwise has access to a comprehensive database of data characterizing the target system's topology (e.g., number of compressors, types and locations of meters, etc), along with metering data and CAGI data sheets from numerous compressor vendors (e.g., Atlas Copco, CompAir, Gardner Denver, Ingersol Rand, Kaeser, Quincy, and Sullair). With such a database populated with a wide cross-section of available air compressor models, vendor-independent assessment tools can be provided to find the most suitable compressor (with respect to efficiency) for a given target system's needs.

Example Deployment Scenario at Customer Site

Assume a customer initiates a project, where its industrial compressed air system is to be measured and evaluated. As part of the request, the customer provides the following information:
Number of air compressors, along with the name/ID of each compressor. A power meter can be provided for each compressor.
Number of supply points (i.e., there may be more than one compressed air supply point). Often, in large systems, there may be multiple compressor rooms located at opposite ends of the loop to keep air pressure even across the distribution system (e.g., piping). Each compressor room may contain multiple air compressors.
For each supply point, the size of the piping and piping material (e.g., black pipe, stainless steel, copper, etc). An airflow and air pressure meter can be placed at each point where compressed air is delivered to the distribution system.
If there are multiple supply points, provide the distance between supply points. In some deployments, there may be a distance threshold for connecting meters to the DLNA, depending on the communication medium (e.g., fiber and some wireless technologies can communicate over long distances, while some copper-based bus and short range wireless technologies are limited to relatively shorter distances).

Once this information is received, the DLNA can be configured accordingly. In addition, each airflow meter, air pressure meter, and power meter to be deployed can be configured and/or labeled with a name/ID. To facilitate deployment, each of the power meter labels can be configured to align with or otherwise match a corresponding one of the air compressor name/IDs. A similar approach can be used for each airflow and air pressure meter to be deployed on corresponding supply points. For instance, in the example embodiment shown in FIG. 1, an RS-485 port for each airflow, air pressure, and power meter is configured, and its port connector labeled with the name/ID of the corresponding meter. As previously indicated, numerous bus/port schemes can be used here, and the present invention is not intended to be limited to any particular scheme.

In addition, the DLNA can be configured with a VPN SSL Certificate that will allow it to securely connect to the analysis server. The data logging parameters of the DLNA can also be set, such as overall time period for data logging, frequency of data logging within that time period, and pre-transmission processing of logged data (e.g., deriving data from logged data, averaging of logged data, compression and/or encryption of logged data). Once configured, the DLNA can be deployed at the customer site (e.g., operatively coupled to the customer's LAN), along with the power, air pressure, and airflow meters at their pre-determined locations. As previously explained, the meters can be connected to the DLNA via cables or other suitable coupling means.

Once installed and operatively coupled to the deployed meters, the DLNA can be powered up, and in some embodiments, is programmed or otherwise configured to automatically establish a VPN connection to the analysis server (e.g., using port 80, which is typically open on most firewalls to all allow for web-browsing). Any necessary reconfiguration and/or updating of the DLNA can be performed remotely via the VPN connection and analysis server. In addition, proper function and data collection of each meter can be verified remotely. If there are problems collecting data on any of the meters, then customer service can work to resolve that problem with assistance of the customer (e.g., via conference call), and/or can travel to customer site to resolve any such issues. Data can be manually extracted from the DLNA, or the DLNA can be configured to deliver data autonomously (via the VPN connection to the server) at the conclusion of each logging period. In some embodiments, logged and/or otherwise derived data can be uploaded to the analysis server in a flat file (or other suitable file type) and imported into a hosted application accordingly.

In one example case, a week's worth of metering data (from airflow, air pressure, and power meters) is collected. Depending on the sampling interval used, the amount of data collected may be significant, which can result in very large data sets being transferred from the DLNA to the server. To alleviate data transfer overhead, the DLNA can be programmed or otherwise configured to summarize and consolidate metering data and/or data derived therefrom. Additional details of such onboard data consolidation will be discussed in turn.

In one example embodiment, the analysis server is configured with application software, that when executed carries out analysis of data provided by the DLNA. In one such case, the application software uses the following metering information from each deployed airflow and air pressure meter: CFM (cubic feet per minute) and PSI (pounds per square inch), respectively. These measurements may be provided by a single multi-purpose meter capable of both airflow and air pressure, or by dedicated airflow and air pressure meters. Airflow data can be captured, for instance, using a CDI 5200 or 5400 flow meter. The pressure meter can be selected from any number of suitable air pressure meters (transducers), depending on factors such as the desired accuracy and range of operating air pressure to be monitored.

Continuing with this example case, the application software of the analysis server uses the following metering information from each deployed power meter: kWh (kilowatt hours) and power factor (the ratio of real power to apparent power). A low power factor indicates loss in the power distribution system and higher energy costs. In addition kWh, note that a typical power meter can also provide amps and voltage on each phase, which can also be used by the application software of the analysis server, for example, during remote verification of the meters by testing the Amps and/or Voltage on each of the three phases.

Data Logging Network Appliance (DLNA)

FIG. 2 is a data logging network appliance (DLNA) configured in accordance with an embodiment of the present invention.

As can be seen, the DLNA includes a processor, a meter polling and logging module (data logger), an alert notification module, a display console module, a data analysis module, an onboard consolidation module, a meter configuration module, a memory/storage module, and a network interface module. Each of the components in this example DLNA are communicatively coupled to one another (via a datacom bus, in this example embodiment), such that each module can communicate with one another, or otherwise be accessed by other modules to carry out functionality described herein. Conventional bus and/or inter-process communication techniques can be used to facilitate this communication between modules as needed. Although modules of the DLNA are shown as separate, in other embodiments, the functionality of some components may be integrated into others. For instance, each of the memory, processor, network interface module, data analysis module, and the onboard consolidation module can be integrated into the data logger, if so desired.

As shown, the meter polling and logging module can be operatively coupled to one or more meters in a compressed air system, such as airflow, air pressure, and power meters as discussed with reference to FIG. 1. In some embodiments, the meter polling and logging module is programmed or otherwise configured to collect and accumulate measurements from these meters (and/or other sensors) on a predefined interval, such as every 3 seconds or twice a day. The meter polling and logging module can provide the harvested data directly to the memory/storage, or to the processor so that any necessary preliminary processing (e.g., data formatting, error checking, etc) can be carried out prior to storage.

The processor generally controls the overall function of the DLNA and executes the various other modules (e.g., network interface, alert notification, display console, data analysis, onboard consolidation, meter polling and logging, and meter configuration modules) to carryout the functionality described herein. The processor of this example embodiment receives data from the meter polling and logging module and provides access to the memory, by way of the data analysis, onboard consolidation, and meter configuration modules. The processor can be implemented with any number of commercially available processors or processing chip sets (e.g., main processor and co-processor), such as ARM® or Intel® processors or any suitable microcontroller having input/output (I/O) and routine execution capability. With meters directly cabled or otherwise operatively coupled to it, the DLNA can record readings from all connected meters at the same time, process them as described herein, store them to the memory/storage, and if so desired, provide those readings (or data derived therefrom) to the analysis server via the network interface.

The DLNA can be installed, for example, in an industrial setting such as a factory having compressed air operations, and operatively connected to an Ethernet LAN via the network interface module, which can be implemented with conventional network interface technology. If the customer has a wireless LAN, then the DLNA can be optionally deployed with a wireless Internet card as its network interface module, thereby allowing for communication by point-to-point, point-to-multipoint, broadcasting, cellular, or other such wireless networks. In some such embodiments, for example, the network interface module can be configured to acquire a local IP address from a DHCP server and then connect to the application server and establish a VPN connection. Other such TCP/IP based schemes can be employed as well. In any such cases, the DLNA can be configured to provide a plug-n-play operation for turn-key data collection and reporting when deployed with selectively placed airflow, air pressure, and power meters. To ease deployment, the meters can be preconfigured and labeled, with matching labels or color coding on the DLNA ports that are in-turn coupled to the corresponding ports of the meter polling and logging module (assuming that polling/logging module is within a larger housing of the DLNA).

Once meters are deployed and the DLNA is up and running, airflow, air pressure, and power data can be recorded (e.g., with timestamp) at a predefined collection interval and overall collection period, such as every 30 seconds or every hour for a week. In general, collecting data for one to two weeks typically allows for building of a profile of airflow and energy use across all work shift and all days, depending on the particular work schedule at the target site. If enough data storage is available in the DLNA (which in this example embodiment is provided by the memory/storage), the sampling interval can be shortened to provide more data (e.g., sample every 3 seconds). The memory/storage can be implemented, for example, with a disk drive or other suitable storage facility such as RAM and/or Flash ROM. The size of the memory/storage can vary depending on anticipated volume of data to be collected, and in some embodiments ranges from 10 Mbytes to 100 Gbytes. In some embodiments, the DLNA (e.g., by operation of the meter polling and logging module or processor) is configured to capture data for a designated time period that is defined by two discrete timestamps (e.g., from start date/time to end date/time). As onboard storage allows, multiple time intervals may be retained and processed.

The onboard consolidation module can be used to process the collected data, so that the data is more concise and otherwise easier to transmit. For instance, collecting measurements on 3 second intervals for a full week results in 201600 records per meter. The resulting data file may be quite large depending on the type of data stored. To reduce data transfer overhead, and in accordance with one example embodiment, the onboard consolidation module is programmed or otherwise configured to compute a single data value that is representative of all data samples collected during a designated time interval that is coarser than the actual sampling interval, such that the single computed data value representative of the entire time interval can be reported. For instance, assume that the meter polling and logging module is configured to operate at a 6 second sampling interval, thereby producing 14400 records/day. Further assume that the onboard consolidation module is programmed or otherwise configured to compute a consolidated data value derived from data sampled over a 6 minute coarse interval, thereby effectively consolidating 14400 records/day into 240 records/day. In one such example embodiment, the average value associated with each coarse interval is reported. In other embodiments, the actual reported measurements include: average, median, mode, and minimum/maximum values for each coarse interval, with all these values formed into a single data value using the following format: average/median/mode/minimum/maximum. A variation on this embodiment is where the actual reported measurements include: average, minimum, and maximum values for each coarse interval, which may also be formed into a single data value using the following format: average/minimum/maximum. Any number of statistically relevant representations can be used to effectively consolidate the measured data. In addition to such data consolidation, the onboard consolidation module may be further configured to store the consolidated values into a flat file. The flat file may then be compressed and/or encrypted by the onboard consolidation module. Other such data consolidation and compression techniques will be apparent in light of this disclosure.

The data analysis module provides additional data processing that can be used to further reduce or otherwise eliminate data transmission overhead. In more detail, aberrant maximum measurements are indicative of “spikes” that may require further scrutiny. Similarly, large discrepancies between the average and median or mode values may be indicative of abnormal activity during the sampling period that merit additional evaluation. The data analysis module is programmed or otherwise configured to detect such anomalies, and if appropriate, take remedial action (e.g., discard suspect data or request additional data). For instance, when a suspected spike or abnormal activity is encountered by the data analysis module due to a difference between consolidated values computed by onboard consolidation module that exceeds a given threshold (e.g., a consolidated value is 20% or more higher than one or both of its temporally neighboring consolidated values), the data analysis module can query the processor to provide all sampled data for the time interval in question; alternatively, the data analysis module can query the memory/storage directly, or via the onboard consolidation module. The data analysis module can then analyze the sampled data and identify and eliminate extraneous or otherwise erratic data points. For instance, the data analysis module can be configured to sort the data in ascending order and eliminate the top 1 to 5 highest and lowest values, or to compute a standard deviation and discard data points outside a given threshold. Once the data set is cleaned, the data analysis module can provide the data back for storage in the memory/storage (e.g., directly, or via the processor or onboard consolidation module). The onboard consolidation module can then be engaged to re-compute the consolidated value for each of the coarse intervals involved.

In one example embodiment, the data analysis module is further programmed or otherwise configured for establishing an airflow-to-power consumption profile of the compressed air system as described herein, wherein the profile is based on actual power consumed by the system, airflow required by the facility, and air pressure provided to the facility. Further recall that compressed air demand associated with the target compressor system can be reduced (e.g., by identifying and fixing leaks, identifying and eliminating inappropriate uses of compressed air, and reducing overall target system air pressure). The data analysis module may further be configured for optimizing supply of compressed air to the compressed air system with a refined view of compressed air usage based on reduced demand, by identifying air compressors and/or supply-side equipment that are properly sized for the compressed air system. Note that this functionality of establishing an airflow-to-power consumption profile and optimizing supply of compressed air by identifying appropriate air compressors and supply-side equipment can be carried out locally to the system (via one or more modules of the DLNA, generally referred to in this example as the data analysis module) or remotely to the system (via one or more modules of the analysis server, such as the analysis application). Thus, such functionality is not intended to be strictly limited to any one module or location, and numerous equivalent configurations will be appreciated in light of this disclosure.

The DLNA can also be queried by the analysis server for records (individual sample records and/or consolidated records) that exceed a designated threshold. This would allow the upstream server to extract detailed records for showing the size and duration of abnormal airflow or power consumption. In this sense, the data analysis module of the DLNA may be implemented at the analysis server, or in both the DLNA and the server, depending on the desired location of the functionality described herein and processor offloading schemes.

Thresholds for event notification can be set through the display console module, which can be implemented with a graphical user interface or other suitable interface that allows a user to interact with and input information. In one example embodiment, when the data analysis module observes a threshold crossing event, it can trigger a notification or alert to the upstream analysis server or a monitoring service through the alert notification module. The threshold value may be defined as a function of time and/or absolute values of sampled data. For example, a plant manager may want to be notified if the airflow in the compressed air system exceeds 100 CFM on the weekend (or during 3rd shift) when the plant is closed, or if power on a main compressor drops to zero in an automated plant. Alerts can be issued by the alert notification module, for example, using SNMP (Simple Network Management Protocol) or other suitable mechanism (e.g., automatic email or messaging system), and can identify the meter reporting the event and the meter value that triggered the event.

The meter configuration module is programmed or otherwise configured to receive and store the settings describing the meters. This information may be, for example, entered and stored by the user by operation of the display console module, or downloaded to the meter configuration module from the analysis server, which received the information from user responses to a worksheet served to and answered by the user. In one example embodiment, the information includes: type of meter (e.g., power, airflow, air pressure); meter make/model; address of the meter on the communication bus or network; description of what is being metered (e.g., name of the compressor or location of the meter in the plant); and thresholds settings for warning and alerts. Each of the onboard consolidation and data analysis modules can access this meter configuration information to assist in data processing (e.g., identify pertinent thresholds), and/or adjust the information if so desired (e.g., adjust pertinent thresholds).

Each of the modules included in the DLNA (e.g., network interface, alert notification, meter configuration, display console, onboard consolidation, meter polling and logging, and data analysis modules) can be implemented, for example, in software (e.g., C, C++, or other suitable instruction set) that is executable by the processor. Alternatively, the modules can be implemented in hardware (e.g., gate-level logic or purpose-built silicon or other integrated circuit or chip set) or a combination of hardware and software (e.g., a microcontroller with a number of input/output ports and embedded routines for carrying out the functionality described herein). In a more general sense, and as will be appreciated in light of this disclosure, the various components of the DLNA can be implemented with any combination of software, hardware, and firmware, and the present invention is not intended to be limited to any particular implementation or configuration.

Analysis Server

FIG. 3 is an analysis server configured in accordance with an embodiment of the present invention. The server can be implemented with conventional server technology, to implement the functionality described herein. In the example embodiment shown, the server includes a processor operatively coupled to a memory, as well as an analysis application module, a network interface module, a customer worksheets and forms module, and a topology and metering results database. The database can be used to define or otherwise characterize the topology (e.g., number of compressors, compressor types, users and typical usages per time of day, meter types and locations thereof) of the target system and store meter data reported by one or more DLNAs. Other information in the database may include, for example, compressor control type comparison data from Compressed Air Challenge® and published CAGI data from major air compressor manufacturers.

The processor generally controls the overall function of the server and executes the various modules (e.g., analysis application module, network interface module, and customer worksheets and forms module) to carryout the functionality described herein. The processor of this example embodiment also receives data and requests from the DLNA and/or workstation at the customer site (or other DLNAs, workstations, or devices capable of communicating with the server), and provides access to the topology and metering results database. The processor can be implemented with any number of commercially available processors or processing chip sets suitable for a server environment. By way of the network, the server can access the memory of the DLNA or otherwise interrogate and/or direct the DLNA. The memory can be implemented, for example, with a solid state drive and/or other suitable storage facilities such as RAM and/or Flash ROM. The server can be installed, for example, remote from the industrial setting where the DLNA and compressor system are located, and accessible by the network using any number of suitable wired and/or wireless communication technologies. In some such embodiments, the server operates under TCP/IP based schemes. In any such cases, the server is accessible by the customer's network.

When the server receives a request for worksheet and other such useful forms, content and/or functionality (e.g., leak calculators, etc), the request is processed through the network interface, and the customer worksheets and forms module operates to provide the appropriate worksheet (or other requested form) that is responsive to the request. The worksheet/form is then served in response to the request. The customer worksheets and forms module also operates to capture any input provided on the worksheet/form. This information can be integrated into the database or otherwise used in analyzing the target system. Any number of web serving technologies, including page building and caching, load balancing schemes (in the event that the server is inundated with requests), authentication, authorization, decryption/encryption, can be employed at the server, as typically done and when appropriate.

The analysis application can be programmed or otherwise configured to analyze data provided by or accessed from the DLNA. In one such case, the analysis application is configured to operate in conjunction with the DLNA (and various deployed sensors) so as to allow a user to effectively carry out the previously described three step methodology, including: 1) establishing a profile of the target system, including a detailed airflow-to-power consumption profile; 2) reducing demand by identifying and fixing leaks, identifying and eliminating inappropriate uses of compressed air, and reducing overall target system air pressure and shrinking artificial demand; and 3) optimizing supply with a refined view of compressed air usage, by identifying air compressors and/or supply-side equipment that are properly sized for the target system and establishing a comprehensive control strategy to meet the varying demands on the target system. In some such embodiments, this methodology is carried out in an automated fashion, once the various components of the system are deployed (e.g., DLNA, air pressure and airflow meters, power meters, leak detector such as ultrasonic acoustic detectors) and various worksheets/forms have been completed. As previously explained, some analysis can be carried out by the DLNA and some by the server, or all analysis can be carried out at one of the DLNA or the server, depending on the desired processing scheme.

System-Based Functionality

What follows is a summary of example operations and functionality, according to one embodiment of the present invention. Each of the functions may be carried out, for example, by the analysis server by remotely accessing the DLNA over the network (e.g., via VPN) and/or by the DLNA itself. The functions can be implemented in software, hardware, or a combination thereof.

Set date/time—set the current date/time on the DLNA. This can be performed locally at the DLNA (e.g., via the display console module) or remotely by the analysis server over the network.

Set sampling period—set up a sampling period where meter data will be saved (e.g., via the processor and/or meter polling and logging module). In one particular embodiment, the following parameters are used when establishing a sampling period: start date and time (in minutes); end date and time (in minutes); sampling interval (frequency of sampling in seconds); and sample period name (name or label given to a sample period, which can be used to uniquely reference a sampling period when performing other operations). Note that in some embodiments, multiple sampling periods can be defined and may overlap one another. In addition, simultaneous sampling periods may be enabled allowed (e.g., 2, 3, or more), so long as the start date/time and end date/time for each sampling period is unique.

Stop a sampling session—terminates an active sampling session (e.g., via the processor and/or meter polling and logging module). The sampling period to be stopped may be referenced, for example, by its name or by its start/end timestamps.

Delete sample period—deletes the sample period definition and all data collected for that sample period (e.g., via the processor and/or data analysis module).

Retrieve sample period status—retrieves the status of one or more sample periods (e.g., via the processor, onboard consolidation module, and/or data analysis module). In some embodiments, sample periods may be referenced by name (including wildcards), or by start and end timestamp, or status (as will be explained). When referencing sample periods by state/end timestamps, only sample sessions that fall within the specified start and end date/times are listed. The following example statuses may be reported for a sample period: Pending—the start date/time for the sample period has not arrived; Active—data for the sampling period is being recorded, meaning that the current date/time is between the sampling period's start and end timestamps; Complete—data for the sampling period has been collected, meaning that the current date/time is after the end timestamp for the sampling period. In one example case, the following parameters are returned for each sample period: start date/time, end date/time, sampling interval (in seconds), name of sampling period, status, and number of samples successfully collected.

Retrieve measurements—retrieve sampled data from an active or completed session (e.g., via the processor, onboard consolidation module, and/or data analysis module of the DLNA, or via the processor or analysis application of the analysis server). In one example case, the following parameters may be used to query measurements from the DLNA: sample period identifier—either sample period name, or start/end timestamp; start date/time—default is start date/time from sample period; end date/time—default is end date/time from sample period (recall that the start and end date/time parameters allow the client to retrieve a subset of the measurements from the sample period); and sample size (in seconds)—default is sampling interval from sample period. In one specific case, if the sample size requested is more than twice the sampling interval for the sampling period, then the measurements within each sample size interval can be summarized into an average and median or mode value, along with the minimum and/or maximum value within each interval are reported. In one such case, if the sample size is less than the sampling interval for the sampling period, then the query is invalid; if the sample size is greater than the sampling interval for the sampling period, but less than three times the sampling interval, then the query is invalid; if the sample size is not an even divisor of the sampling interval for the sample period, then the query is invalid. For example: if the sampling interval is 3 seconds, and the requested sample size is 60 seconds, then the request is valid. But if the requested sample size is 61 seconds, then the sampling size is invalid because when the sample size (61) is divided by sampling interval (3) it leaves a non-zero remainder (1). Alternatively, the system can be configured to automatically choose an operative sampling size that is closest to the requested sampling size.

In one example embodiment, when retrieving measurements, the following attributes are returned:
Timestamp—the date/time that the sample was taken
If the sample size and sampling interval are equal, then
   For each power meter connected to the DLNA,
      Meter ID—identifies the power meter (to which there is a corresponding air compressor)
      kWh—Kilowatt hours consumed
      Power factor
   For each airflow meter connected to the DLNA
      Meter ID—Identifies the airflow meter
      CFM (cubic feet/minute) of airflow
      Air Pressure (PSI), if available
If the sample size and sampling interval are not equal, but meet the criteria described above, then:
   For each power meter connected to the DLNA,
      Meter ID—identifies the power meter and corresponding compressor
      Max kWh—Maximum kilowatt hours measured in sampling segment
      Average kWh—average kilowatt hours measured in the sampling segment
      Median and/or Mode kWh—median/mode kilowatt hours measured in the sampling segment
      Average Power factor measured in the samples
   For each airflow meter connected to the DLNA
      Meter ID—Identifies the airflow meter
      Max CFM (cubic feet/minute) of airflow—maximum airflow measured in sampling segment
      Average CFM (cubic feet/minute) of airflow—average airflow measured in sampling segment
      Median and/or Mode CFM (cubic feet/minute) of airflow—median/mode airflow measured in sampling segment
      Max Air Pressure (PSI), if available—maximum airflow measured in sampling segment
      Average Air Pressure (PSI), if available—average airflow measured in sampling segment
      Median and/or Mode Air Pressure (PSI), if available—median/mode airflow measured in sampling segment
         Even though there may be more parameters reported with the summarized data, the number of records will typically be an order of magnitude (or more) smaller than a typical data extraction.

Upstream Communications (from DLNA to Server)

As previously explained, and in accordance with one example embodiment, when the DLNA is installed at a customer site and connected to the customer's LAN, the DLNA can be configured, for example, to acquire a local IP address from the DHCP server. If there is no DHCP server at the customer location, then a fixed IP address can be assigned to the DLNA prior to deployment. Once installed, the DLNA can then establish a VPN connection with the analysis server. The VPN certificate can be pre-installed in the DLNA, prior to deployment to the customer. In some such cases, the VPN communications use port 80 (the same port used for web-browsing). A local debugging capability can be used if the firewall or Internet service blocks communications, as typically done. All upstream communications can be implemented, for example, using XML or web-services.

Downstream Communications (from Server to DLNA)

Communications to meters can be implemented, for instance, via direct cable connections or wireless communication links. The DLNA can communicate with meters, for example, via a RS-485 Modbus cable. Up to 32 power, airflow, and air pressure meters may be connected to this bus, in some such embodiments. A minimum typical configuration is 1 to 3 power meters and 1 to 3 airflow and air pressure meters. However, in large deployments there could be 20 or more airflow and air pressure meters and 12 or more power meters. Note, however, that it is not necessary to connect all of these devices to a single DLNA. For instance, some system configurations may employ two or more DLNAs, where the DLNAs are synchronized by a clock signal provided on the communication bus or other suitable synchronization means. The bus/DLNA clock can in turn be synchronized with a clock on the server.

Methodology

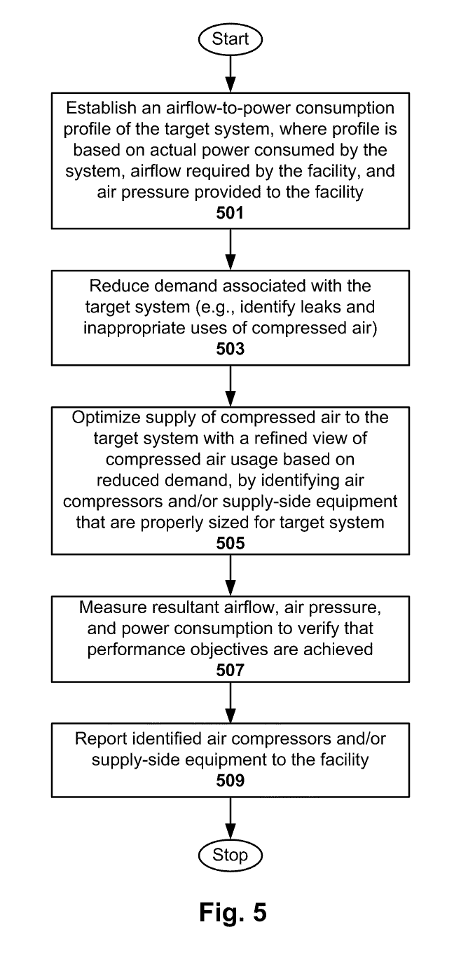

FIG. 5 illustrates a method for monitoring and analyzing a target compressed air system deployed at a facility, in accordance with an embodiment of the present invention. The method can be carried out, for example, by one or more modules of the DLNA and/or analysis server shown in FIG. 1, as will be appreciated in light of this disclosure.

The method includes establishing 501 an airflow-to-power consumption profile of the target system, wherein the profile is based on actual power consumed by the system, airflow required by the facility, and air pressure provided to the facility. Recall that, in addition to power, airflow and/or air pressure data from meters deployed at the system, other information about the system may also be provided by a manager (or other personnel) of the system (e.g., via online worksheets).

The method continues with reducing 503 demand associated with the target system. Reducing demand associated with the target system may include, for example, identifying and fixing leaks, identifying and eliminating inappropriate uses of compressed air, and reducing overall target system air pressure. In some such cases, some of the functionality included in reducing 503 can be automated (such as the identifying steps), while other functions of the reducing 503 can be carried out manually (such as the fixing and eliminating steps). Thus, in one specific embodiment, reducing 503 includes identifying at least one of leaks and inappropriate uses of compressed air, to assist in reducing overall target system air pressure.

The method continues with optimizing 505 supply of compressed air to the target system with a refined view of compressed air usage based on reduced demand, by identifying air compressors and/or supply-side equipment that are properly sized for the target system. Recall this may include, for example, a comparative analysis of different compressors capabilities to meet the reduced demand and airflow-to-power consumption profile, based on data sheets publicly available from CAGI and accessible to the optimization routine via a database.

The method may further continue with one or both of measuring 507 resultant airflow, air pressure, and power consumption to verify that performance objectives are achieved after optimization of step 505, and reporting 509 these identified air compressors and/or supply-side equipment to the facility. In one particular case, the method is carried out at least in part remotely from the facility. For instance, in one such example case, the method includes providing consolidated data collected at the facility to a remote server where the establishing and optimizing is carried out.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A data logging network appliance (DLNA) device, comprising:
a data logger for logging parameters associated with a compressed air system deployed at a facility; and
a consolidation module for consolidating logged data.

2. The device of claim 1 further comprising:
a data analysis module for analyzing the logged data for unexpected data.

3. The device of claim 2 wherein in response to detecting unexpected data, the data analysis module causes an alert to be issued.

4. The device of claim 1 further comprising:
a data analysis module for establishing an airflow-to-power consumption profile of the compressed air system, wherein the profile is based on actual power consumed by the system, airflow required by the facility, and air pressure provided to the facility.

5. The device of claim 1 further comprising:
a data analysis module for optimizing supply of compressed air to the compressed air system with a refined view of compressed air usage based on reduced demand, by identifying air compressors and/or supply-side equipment that are properly sized for the compressed air system.

6. The device of claim 1 wherein the data logger is adapted to receive data from one or more airflow meters, and one or more power meters.

7. The device of claim 6 wherein the data logger is further adapted to receive data from at least one of an air pressure meter and an ultrasonic acoustic detector.

8. The device of claim 1 wherein the device is capable of operatively coupling to a network and communicating with a remote server.

9. The device of claim 1 wherein the onboard consolidation module is configured to compute a single data value that is representative of all data samples collected during a designated time interval.

10. The device of claim 9 wherein the single data value is an average value of all data samples collected during a designated time interval.

11. The device of claim 1 wherein the onboard consolidation module is configured to compute at least one of average, median, mode, minimum, and maximum values for a set of data samples collected during a designated time interval.

12. A data logging network appliance (DLNA) device, comprising:
a data logger for logging parameters associated with a compressed air system deployed at a facility, wherein the data logger is adapted to receive data from one or more airflow meters, one or more air pressure meters, and one or more power meters;
a consolidation module configured to compute at least one of average, median, mode, minimum, and maximum values for a set of data samples collected during a designated time interval;
a data analysis module for analyzing the logged data for unexpected data; and
a network interface for operatively coupling to a network and communicating consolidated values computed by the consolidation module to a remote server.

13. The device of claim 12 wherein in response to detecting unexpected data, the data analysis module causes an alert to be issued.

14. The device of claim 12 wherein the data logger is further adapted to receive data from an ultrasonic acoustic detector.

15. The device of claim 12 wherein the data logger is further configured to compute an average value of all data samples collected during the designated time interval, and a plurality of such average values are reported to the remote server.

16. The device of claim 12 wherein at least one of the device or the remote server is capable of establishing an airflow-to-power consumption profile of the compressed air system, and for optimizing supply of compressed air to the compressed air system with a refined view of compressed air usage based on reduced demand, by identifying air compressors and/or supply-side equipment that are properly sized for the compressed air system, wherein the airflow-to-power consumption profile is based on actual power consumed by the system, airflow required by the facility, and air pressure provided to the facility.

17. A method for monitoring and analyzing a target compressed air system deployed at a facility, comprising:
establishing an airflow-to-power consumption profile of the target system, wherein the profile is based on actual power consumed by the system, airflow required by the facility, and air pressure provided to the facility;
reducing demand associated with the target system; and
optimizing supply of compressed air to the target system with a refined view of compressed air usage based on reduced demand, by identifying air compressors and/or supply-side equipment that are properly sized for the target system.

18. The method of claim 17 where reducing demand associated with the target system comprises:
identifying at least one of leaks and inappropriate uses of compressed air, to assist in reducing overall target system air pressure.

19. The method of claim 17 wherein the method further comprises providing consolidated data collected at the facility to a remote server where the establishing and optimizing is carried out.

20. The method of claim 17 wherein the method further comprises at least one of:
measuring resultant airflow, air pressure, and power consumption to verify that performance objectives are achieved after optimizing; and
reporting identified air compressors and/or supply-side equipment to the facility.
